(19) United States
(12) Patent Application Publication
(10) Pub. No.: US 2005/0068301 A1
(43) Pub. Date: Mar. 31, 2005

(54) [KEYBOARD CONTROLLER UPDATING PROCESS]

(76) Inventor: Fang-Hao Kuo, Taipei County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 10/605,421

(22) Filed: Sep. 30, 2003

(51) Int. Cl. G09G 5/00

(52) U.S. Cl. 345/168

(57) ABSTRACT

A keyboard controller (KBC) updating process in a computer system is provided in the present invention. The process provides KBC data and a KBC flash utility to be combined and embedded into a basic input/output system read-only memory (BIOS ROM). The BIOS checks the versions of the KBC data embedded in the BIOS ROM and the KBC in the system. If the version of the embedded KBC is newer than the version of the KBC in the system, a KBC flashing process is performed during a POST of the system.

### BACKGROUND OF INVENTION

1. Field of the Invention

The present invention relates to a keyboard controller (KBC) updating process in a computer system. More particularly, the present invention relates to a KBC updating process by embedding a KBC in a basic input/output system (BIOS) for computers.

2. Description of the Related Art

In a computer system, a keyboard controller (KBC) controls a key input from a keyboard or a pointing device of a computer. A basic input/output system (BIOS) is basic software stored in a read-only memory (ROM) for basic operation of the computer. KBC updating is often required during manufacture of computers and maintenance of computer software.

A KBC updating process usually accompanies and follows a BIOS updating process. FIG. 1 is a flow chart showing steps of BIOS and KBC updating processes in a computer system. In the steps 102 through 108, a BIOS designing tool is provided to build a BIOS including BIOS data and a BIOS flash utility, and a KBC designing tool is provided to build a KBC including KBC data and a KBC flash utility, and the system gets the BIOS flash utility, the KBC flash utility, the BIOS data and the KBC data for rebooting. As shown in the steps 112 through 116, the BIOS is flashed by using the BIOS flash utility. After the completion of flash of the BIOS, a system rebooting is started. In the following steps 122 through 126, a KBC flashing process is performed and the system is again rebooted. The whole updating process ends upon the completion of the step 162 and then the system is ready to use.

Thus, in a conventional procedure for KBC updating, two separate processes are actually required to complete the procedure. For computer manufacturers, the use of two processes cost more rebooting time and lower production efficiency. For computer users, the conventional process is bothersome and confusing since BIOS updating and KBC updating require use of different flash utilities.

On the other hand, newly developed computers are becoming more light and handy and have a legacy-free interface. A computer“s base unit usually carries no floppy drive. However, the conventional KBC flash process requires a floppy drive. A user of a legacy-free computer has to choose to use a USB (Universal Serial Bus) floppy drive to flash a KBC; the use of a USB floppy drive is involuntary, restrictive and inconvenient. The use of a floppy drive may also be problematic by increasing chances of updating process failures caused by defects of floppy disks, which increases maintenance time and costs. For computer manufacturers, on the other hand, use of a USB floppy drive to boot a computer system is time consuming and thus significantly lowers the efficiency of a production line.

Apparently, the conventional KBC updating processes have certain shortcomings for both computer manufacturing and system maintenance. Therefore, there is a need to improve the processes of updating KBC for enhancing manufacturing efficiency and protecting users” consumer interests.

### SUMMARY OF INVENTION

In the light of the foregoing, the present invention is to provide a process of KBC updating by embedding a newly designed KBC in a BIOS ROM during an updating process so as to enhance manufacturing and operational efficiency and lower costs.

The present invention is to provide a process of KBC updating that incorporates a KBC updating process with a BIOS updating process, which avoids updating KBC in a separate process and thus eliminates one system rebooting operation.

The present invention is to provide a process of KBC updating for a computer, which renders advantageously the use of a floppy drive unnecessary.

In accordance to the above objects and other advantages of the present invention, as broadly embodied and described herein, the KBC updating process of the present invention comprises use of a KBC designing tool to create a KBC including a KBC flash utility and KBC data. The process also comprises use of a BIOS designing tool to amend a BIOS flash utility and combine the amended BIOS flash utility and the KBC into a BIOS ROM. Thus, the newly amended KBC is embedded in the BIOS.

The process further comprises, during a power-on self-test (POST) in a rebooting process, the BIOS checking whether the version of the embedded KBC is newer than that of the original KBC in the system. If the original KBC in the system is in a newer version, the rebooting process is allowed to be completed without any other system operation. If the original KBC in the system is otherwise in an older version, however, data in the KBC ROM is shadowed to a memory address. Subsequently, the KBC flash utility stored in the BIOS ROM is called to read the data stored in the memory address, and the KBC flashing begins to update the KBC.

It is to be understood that both the foregoing general description and the following detailed description are exemplary, and are intended to provide further explanation of the invention as claimed.

### BRIEF DESCRIPTION OF DRAWINGS

The accompanying drawings are included to provide a further understanding of the invention, and are incorporated in and constitute a part of this specification. The drawings illustrate embodiments of the invention and, together with the description, serve to explain the principles of the invention. The drawings are as follows.

FIG. 1 is a flow chart describing a conventional KBC updating process.

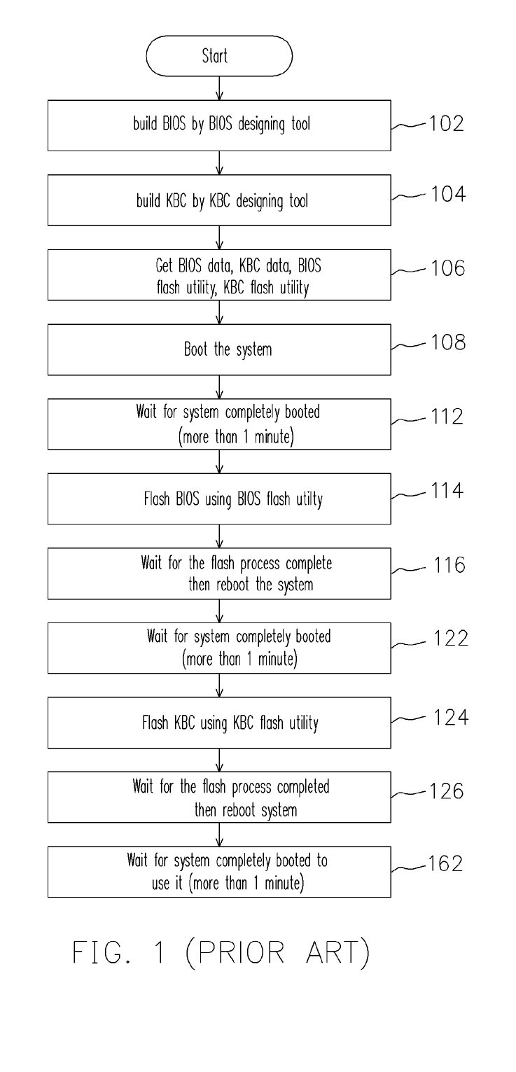

FIG. 2 is a flow chart describing a KBC updating process according to one preferred embodiment of the invention.

FIG. 3 is a flow chart describing a KBC updating process according to another preferred embodiment of the invention.

### DETAILED DESCRIPTION

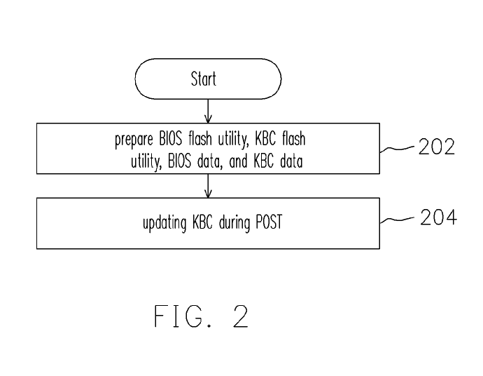

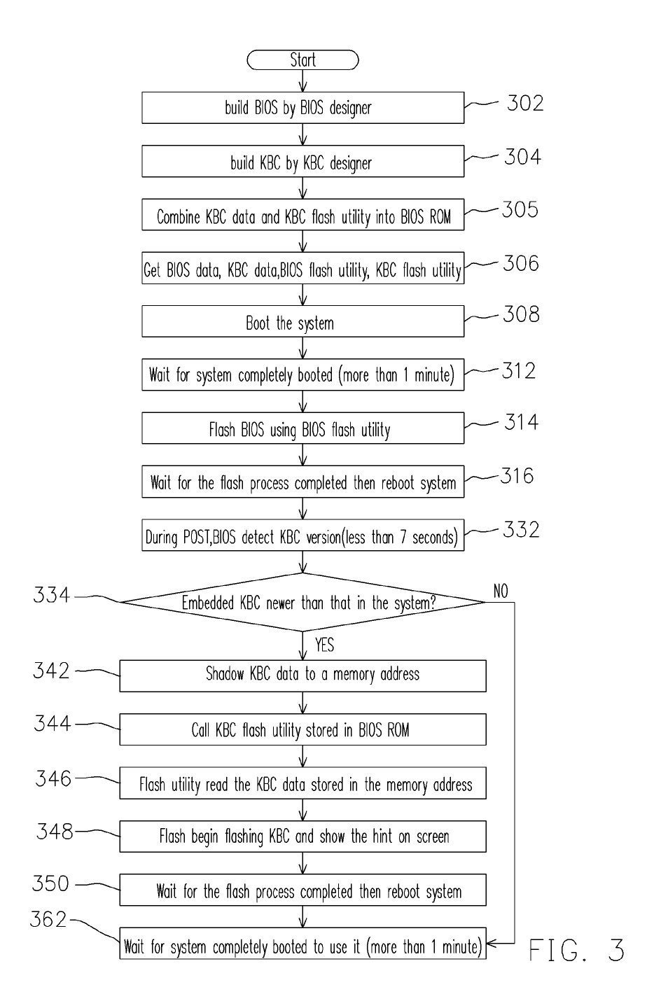

The following description to the preferred embodiments of the present invention, as illustrated in the accompanied FIGS. 2 and 3, is set forth, for the purpose of explanation and not limitation, to provide a thorough understanding of the present invention.

Referring to FIG. 2 in accordance with one preferred embodiment of the invention, a BIOS data, a BIOS flash utility, a KBC data and a KBC flash utility are first prepared in a system, for example, a computer system (step 202). The KBC updating process is then performed during a power-on self-test (POST) of the system (step 204).

Referring to FIG. 3 in accordance with another preferred embodiment of the invention, a BIOS designer is provided to build a BIOS data and a BIOS flash utility (step 302), and a KBC designer is provided to build a KBC data and a KBC flash utility (step 304). It is noted that the KBC data and the KBC flash utility are then combined into a BIOS, which includes the built BIOS data and BIOS flash utility as shown in the step 305. The system then gets the BIOS by storing the BIOS into a storage device, such as hard disk or even a BIOS ROM in which BIOS of the system is stored, and the system begins to be booted (step 308). After the completion of the system booting, the BIOS of the system is flashed out by using the BIOS flash utility, and the BIOS stored in the storage device is flashed into the BIOS ROM (step 314). A system rebooting is then started (step 316) upon the completion of the flash process.

Further referring to FIG. 3, the present invention further comprises a step that, during a power-on self-test (POST) of the system, the BIOS detects versions of the KBC embedded in the BIOS ROM and of the KBC originally stored in the system (step 332) to determine which version is newer than the other (step 334).

When the foregoing detection in the step 332 indicates that the version of the embedded KBC is not newer than that of the KBC in the system, i.e., an update process of the KBC is rendered unnecessary, the system is ready for using after the completion of the ongoing system rebooting as shown in the step 362.

On the other hand, however, when the version of the embedded KBC is newer than that of the KBC in the system, update of the KBC in the system by the embedded KBC is subsequently performed as shown in the steps 342 through 350. First, the KBC data, which is combined into the BIOS, is shadowed to a memory address, for example 8000:0000 (step 342). The KBC flash utility stored in the BIOS ROM is called (step 344) and then reads the data stored in the memory address (step 346). Further, KBC flashing begins by using the KBC flash utility (step 348). Upon the completion of the flash, a system rebooting begins (step 350). When the system rebooting comes to an end (step 362), the system is ready for use.

As described above, in the preferred embodiments of the present invention, the KBC flash utility and the KBC data are combined into the BIOS ROM. One of the advantages of this approach is that, in a subsequent step, the BIOS can compare the version of the KBC embedded in the BIOS ROM with the version of the KBC in the system, which can avoid unnecessary KBC updating process.

Moreover, since the KBC flash utility is embedded in the BIOS ROM, conventional flash process by using a floppy drive is advantageously rendered unnecessary, which enhances system reliability and saves time and costs.

It will be apparent to those skilled in the art that various modifications and variations can be made to the structure of the present invention without departing from the scope or spirit of the invention. In view of the foregoing, it is intended that the present invention covers modifications and variations of this invention provided they fall within the scope of the following claims and their equivalents.

1. A keyboard controller (KBC) updating process in a computer system, comprising the steps of:
preparing a basic input/output system (BIOS) flash utility, a KBC flash utility, a BIOS data and a KBC data in the system; and
updating the KBC data during a power-on self-test (POST) of the system.

2. The KBC updating process as in claim 1, wherein the preparing step further comprises:
building a BIOS including the BIOS data and the BIOS flash utility by using a BIOS designing tool;
building a KBC including the KBC data and the KBC flash utility by using a KBC designing tool;
combining the KBC into the BIOS; and
getting the resultant BIOS in the system.

3. The KBC updating process as in claim 1, further comprising flashing a BIOS ROM in the system by using the BIOS flash utility between the preparing step and the updating step.

4. The KBC updating process as in claim 1, wherein the updating step further comprises:
detecting version of the KBC data of the resultant BIOS and version of the KBC in the system by using the BIOS flash utility for determining whether the version of the KBC data is newer than the version of the KBC in the system; and
flashing the KBC in the system, if the version of the KBC data is newer than the version of the KBC in the system.

5. The KBC updating process as in claim 4, wherein the step of flashing the KBC in the system further comprises the steps of:
shadowing the KBC data to a memory address;
calling the KBC flash utility;
reading by the KBC flash utility the KBC data stored in the memory address; and
flashing the KBC in the system by using the KBC flash utility.
